(19) United States
(12) Patent Application Publication
(10) Pub. No.: US 2023/0262223 A1
(43) Pub. Date: Aug. 17, 2023

(54) A Method, An Apparatus and a Computer Program Product for Video Encoding and Video Decoding

(71) Applicant: Nokia Technologies Oy, Espoo (FI)

(72) Inventors: Ramin GHAZNAVI YOUVALARI, Tampere (FI); Jani LAINEMA, Tampere (FI)

(21) Appl. No.: 18/007,504

(22) PCT Filed: May 27, 2021
(86) PCT No.: PCT/EP2021/064190

§ 371 Date: Dec. 1, 2022

Related U.S. Application Data
(60) Provisional application No. 63/034,120, filed on Jun. 3, 2020.

(51) Int. Cl. H04N 19/132; H04N 19/105; H04N 19/159; H04N 19/176

(52) U.S. Cl. CPC H04N 19/132; H04N 19/105; H04N 19/159; H04N 19/176

(57) ABSTRACT

The embodiments relate to a method and a technical equipment for implementing the method. The method includes receiving a picture to be encoded; performing at least one prediction according to a first prediction mode for samples inside a block of the picture in a current channel; deriving an intra prediction mode from at least one coded block in a reference channel; performing at least one other prediction according to the derived intra prediction mode for the samples inside the block of the picture; and determining a final prediction of the block based on said at least one first and at least one second predictions with weights.

### TECHNICAL FIELD

The present solution generally relates to video encoding and video decoding.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided a method comprising
receiving a picture to be encoded;
performing at least one prediction according to a first prediction mode for samples inside a block of the picture in a current channel;
deriving an intra prediction mode from at least one coded block in a reference channel;
performing at least one other prediction according to the derived intra prediction mode for the samples inside the block of the picture; and
determining a final prediction of the block based on said at least one first and at least one second predictions with weights.

According to a second aspect, there is provided an apparatus comprising at least one processor, memory including computer program code, the memory and the computer program code configured to, with the at least one processor, cause the apparatus to perform at least the following:
receive a picture to be encoded;
perform at least one prediction according to a first prediction mode for samples inside a block of the picture in a current channel;
derive an intra prediction mode from at least one coded block in a reference channel;
perform at least one other prediction according to the derived intra prediction mode for the samples inside the block of the picture; and
determine a final prediction of the block based on said at least one first and at least one second predictions with weights.

According to a third aspect, there is provided an apparatus comprising
means for receiving a picture to be encoded;
means for performing at least one prediction according to a first prediction mode for samples inside a block of the picture in a current channel;
means for deriving an intra prediction mode from at least one coded block in a reference channel;
means for performing at least one other prediction according to the derived intra prediction mode for the samples inside the block of the picture; and
means for determining a final prediction of the block based on said at least one first and at least one second predictions with weights.

According to a fourth aspect, there is provided a computer program product comprising computer program code configured to, when executed on at least one processor, cause an apparatus or a system to
receive a picture to be encoded;
perform at least one prediction according to a first prediction mode for samples inside block of the picture in a current channel;
derive an intra prediction mode from at least one coded block in a reference channel;
perform at least one other prediction according to the derived intra prediction mode for the samples inside the block of the picture; and
determine a final prediction of the block based on said at least one first and at least one second predictions with weights.

According to an embodiment, the first prediction is performed in a cross-component linear mode.

According to an embodiment, the derived intra prediction mode is derived from at least one collocated block in channel different from the current channel.

According to an embodiment, the derived intra prediction mode is derived from at least one neighboring block in the current channel.

According to an embodiment, the derived intra prediction mode is determined based on a texture analysis method from reconstructed neighboring samples of the current channel.

According to an embodiment, the texture analysis method is one of the following: a decoder-side intra derivation method; template matching-based method; intra block copy method.

According to an embodiment, the determination from the neighboring samples considers direction of the first prediction.

According to an embodiment, final prediction comprises combined first and second predictions with a constant equal weight for entire samples of the block.

According to an embodiment, final prediction comprises combined first and second predictions with a constant unequal weights for entire samples of the block

According to an embodiment, final prediction comprises combined first and second predictions with equal or unequal sample-wise weighting where the weights of each predicted sample differ from each others.

According to an embodiment, weight values of the samples are decided based on prediction direction or mode identifier of a derived intra prediction mode.

According to an embodiment, weight values of the samples are decided based on prediction direction, location of reference samples or mode identifier of the cross-component linear mode.

According to an embodiment, weight values of the samples are decided based on the prediction directions, the locations of the reference samples or the mode identifiers of the cross-component linear and derived prediction modes.

According to an embodiment, weight values of the samples are decided based on the size of the block.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of an encoding process;

FIG. 2 shows an example of a decoding process;

FIG. 3 shows an example of locations of samples of the current block;

FIG. 4 shows an example of four reference lines neighboring to a prediction block;

FIG. 5 shows an example of matrix weighted intra prediction process;

FIG. 6 illustrates a coding block in chroma channel and its collocated block in luma channel;

FIG. 7 illustrates a coding block in chroma channel and a block in a certain neighbourhood of the collocated block in luma channel;

FIG. 8 illustrates the blending/combining process of the joint prediction method;

FIG. 9 is a flowchart illustrating a method according to an embodiment; and

FIG. 10 shows an apparatus according to an embodiment.

### DESCRIPTION OF EXAMPLE EMBODIMENTS

In the following, several embodiments will be described in the context of one video coding arrangement. It is to be noted, however, that the present embodiments are not necessarily limited to the this particular arrangement.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (I EC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

The Versatile Video Coding standard (VVC, H.266, or H.266/VVC) is presently under development by the Joint Video Experts Team (JVET), which is a collaboration between the ISO/IEC MPEG and ITU-T VCEG.

Some key definitions, bitstream and coding structures, and concepts of H.264/AVC and HEVC and some of their extensions are described in this section as an example of a video encoder, decoder, encoding method, decoding method, and a bitstream structure, wherein the embodiments may be implemented. Some of the key definitions, bitstream and coding structures, and concepts of H.264/AVC are the same as in HEVC standard—hence, they are described below jointly. The aspects of various embodiments are not limited to H.264/AVC or HEVC or their extensions, but rather the description is given for one possible basis on top of which the present embodiments may be partly or fully realized.

Video codec may comprise an encoder that transforms the input video into a compressed representation suited for storage/transmission and a decoder that can uncompress the compressed video representation back into a viewable form. The compressed representation may be referred to as a bitstream or a video bitstream. A video encoder and/or a video decoder may also be separate from each other, i.e. they need not to form a codec. The encoder may discard some information in the original video sequence in order to represent the video in a more compact form (that is, at lower bitrate).

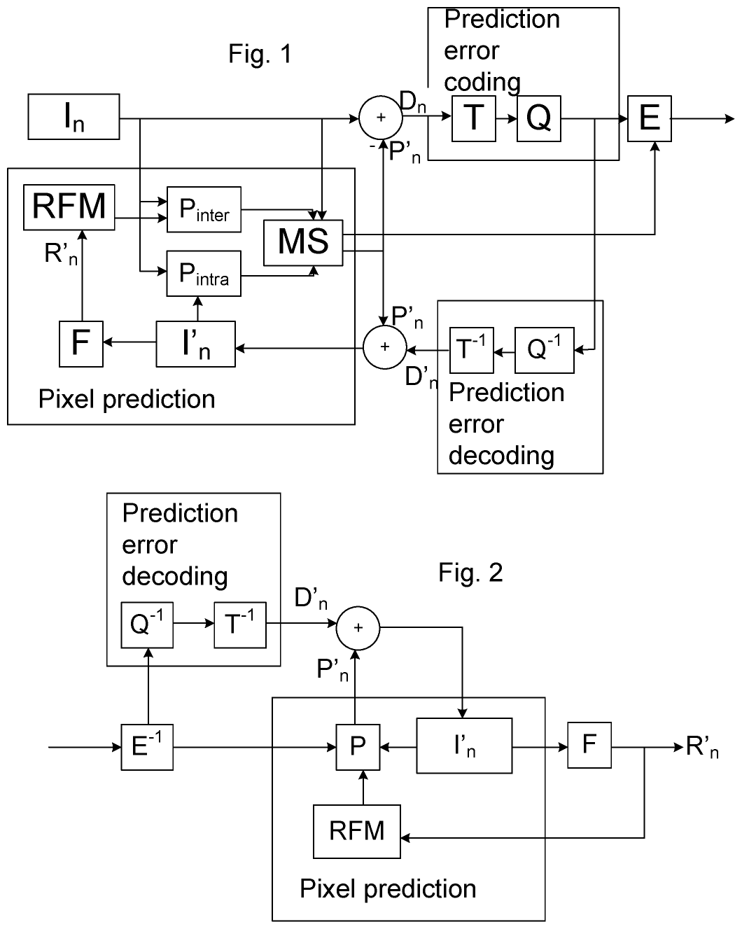

An example of an encoding process is illustrated in FIG. 1. FIG. 1 illustrates an image to be encoded (Iₙ); a predicted representation of an image block (P′ₙ); a prediction error signal (Dₙ); a reconstructed prediction error signal (D′ₙ); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ); mode selection (MS) and filtering (F). An example of a decoding process is illustrated in FIG. 2. FIG. 2 illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

Hybrid video codecs, for example ITU-T H.263, H.264/AVC and HEVC, may encode the video information in two phases. At first, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. One of the benefits of the inter prediction is that they may reduce temporal redundancy.

In intra prediction, pixel or sample values can be predicted by spatial mechanisms. Intra prediction involves finding and indicating a spatial region relationship, and it utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

In the syntax prediction, which may also be referred to as parameter prediction, syntax elements and/or syntax element values and/or variables derived from syntax elements are predicted from syntax elements (de)coded earlier and/or variables derived earlier. Non-limiting examples of syntax prediction are provided below.

In motion vector prediction, motion vectors e.g. for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g. from coding tree units (CTUs) to coding units (CUs) and down to prediction units (PUs), may be predicted. Partitioning is a process a set is divided into subsets such that each element of the set may be in one of the subsets. Pictures may be partitioned into CTUs with a maximum size of 128×128, although encoders may choose to use a smaller size, such as 64×64. A coding tree unit (CTU) may be first partitioned by a quaternary tree (a.k.a. quadtree) structure. Then the quaternary tree leaf nodes can be further partitioned by a multi-type tree structure. There are four splitting types in multi-type tree structure, vertical binary splitting, horizontal binary splitting, vertical ternary splitting, and horizontal ternary splitting. The multi-type tree leaf nodes are called coding units (CUs). CU, PU and TU (transform unit) have the same block size, unless the CU is too large for the maximum transform length. A segmentation structure for a CTU is a quadtree with nested multi-type tree using binary and ternary splits, i.e. no separate CU, PU and TU concepts are in use except when needed for CUs that have a size too large for the maximum transform length. A CU can have either a square or rectangular shape.

In filter parameter prediction, the filtering parameters e.g. for sample adaptive offset may be predicted.

Prediction approaches using image information from a previously coded image can also be called as inter prediction methods which may also be referred to as temporal prediction and motion compensation. Prediction approaches using image information within the same image can also be called as intra prediction methods.

Secondly, the prediction error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate).

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, a picture is divided into a mesh of rectangles, for each of which a similar block in one of the reference pictures is indicated for inter prediction. The location of the prediction block is coded as a motion vector that indicates the position of the prediction block relative to the block being coded.

Video coding standards may specify the bitstream syntax and semantics as well as the decoding process for error-free bitstreams, whereas the encoding process might not be specified, but encoders may just be required to generate conforming bitstreams. Bitstream and decoder conformance can be verified with the Hypothetical Reference Decoder (HRD). The standards may contain coding tools that help in coping with transmission errors and losses, but the use of the tools in encoding may be optional and decoding process for erroneous bitstreams might not have been specified.

A syntax element may be defined as an element of data represented in the bitstream. A syntax structure may be defined as zero or more syntax elements present together in the bitstream in a specified order.

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g. in a coded bitstream e.g. using the Video Usability Information (VUI) syntax of HEVC or alike. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Coding formats or standards may allow to code sample arrays as separate color planes into the bitstream and respectively decode separately coded color planes from the bitstream. When separate color planes are in use, each one of them is separately processed (by the encoder and/or the decoder) as a picture with monochrome sampling.

The Versatile Video Coding (VVC) proposes new coding tools. These include, for example, intra prediction; inter-picture prediction; transform, quantization and coefficients coding;

entropy coding; in-loop filter; screen content coding; 360-degree video coding; high-level syntax and parallel processing. Details of these tools are shortly described in the following:
Intra prediction
   67 intra mode with wide angles mode extension
   Block size and mode dependent 4 tap interpolation filter
   Position dependent intra prediction combination (PDPC)
   Cross component linear model intra prediction (CCLM)
   Multi-reference line intra prediction
   Intra sub-partitions
   Weighted intra prediction with matrix multiplication
Inter-picture prediction
   Block motion copy with spatial, temporal, history-based, and pairwise average merging candidates
   Affine motion inter prediction
   sub-block based temporal motion vector prediction
   Adaptive motion vector resolution
   8×8 block-based motion compression for temporal motion prediction
   High precision ( 1/16 pel) motion vector storage and motion compensation with 8-tap interpolation filter for luma component and 4-tap interpolation filter for chroma component
   Triangular partitions
   Combined intra and inter prediction
   Merge with motion vector difference (MVD) (MMVD)
   Symmetrical MVD coding
   Bi-directional optical flow
   Decoder side motion vector refinement
   Bi-prediction with CU-level weight
Transform, quantization and coefficients coding
   Multiple primary transform selection with DCT2, DST7 and DCT8
   Secondary transform for low frequency zone
   Sub-block transform for inter predicted residual
   Dependent quantization with max QP increased from 51 to 63
   Transform coefficient coding with sign data hiding
   Transform skip residual coding
Entropy Coding
   Arithmetic coding engine with adaptive double windows probability update
In loop filter
   In-loop reshaping
   Deblocking filter with strong longer filter
   Sample adaptive offset
   Adaptive Loop Filter
Screen content coding:
   Current picture referencing with reference region restriction
360-degree video coding
   Horizontal wrap-around motion compensation
High-level syntax and parallel processing
   Reference picture management with direct reference picture list signalling
   Tile groups with rectangular shape tile groups

In VVC, each picture may be partitioned into coding tree units (CTUs) similar to HEVC. A picture may also be partitioned into slices, tiles, bricks and sub-pictures. CTU may be split into smaller CUs using quaternary tree structure. Each CU may be partitioned using quad-tree and nested multi-type tree including ternary and binary split. There are specific rules to infer partitioning in picture boundaries. The redundant split patterns are disallowed in nested multi-type partitioning.

To reduce cross-component redundancy, a cross-component linear model (CCLM) prediction mode is used in the VVC, for which the chroma samples are predicted based on the reconstructed luma samples of the same CU by using a linear model as follows:

pred_{c}(i,j)=α·rec_{L}′(i,j)+β

where pred_{c}(i,j) represents the predicted chroma samples in a CU and rec_{L}′(i,j) represents the downsampled reconstructed luma samples of the same CU.

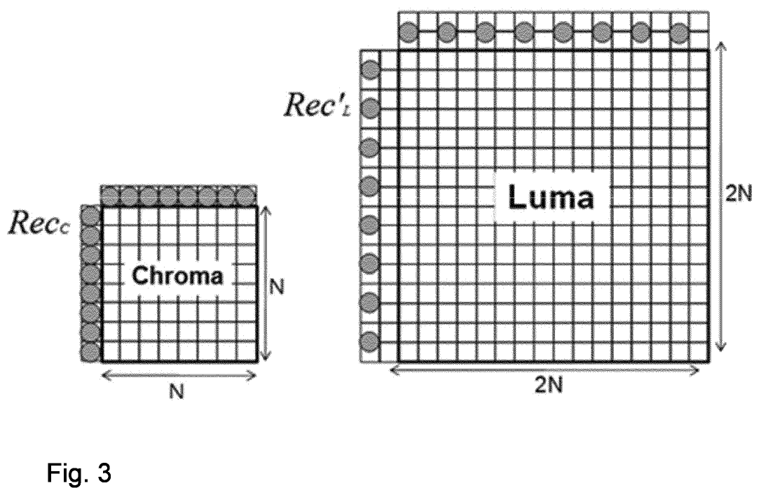

The CCLM parameters (α and β) are derived with at most four neighbouring chroma samples and their corresponding down-sampled luma samples. FIG. 3 shows an example of the location of the left and above samples and the sample of the current block involved in the CCLM mode, i.e. locations of the samples used for derivation of α and β. In FIG. 3 Rec_{c} and Rec′_{L} are shown, where Rec′_{L} is for the downsampled reconstructed luma samples, and Rec_{c} is for the reconstructed chroma samples.

Suppose the current chroma block dimensions are W×H, then W′ and H′ are set as
W′=W, H′=H when LM mode is applied;
W′=W+H when LM-A mode is applied;
H′=H+W when LM-L mode is applied;

The above neighbouring positions are denoted as S[0, −1]_ . . . S[W′−1, −1] and the left neighbouring positions are denoted as S[−1, 0] . . . S[−1, H′−1].

Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM-A mode is applied or only the above neighbouring samples are available;
S[−1, H′/8], S[−1, 3*H′/8], S[−1, 5*H′/8], S[−1, 7*H′/8] when LM-L mode is applied or only the left neighbouring samples are available;

The four neighbouring luma samples at the selected positions are down-sampled and compared four times to find two smaller values: x0A and x1A, and two larger values: x0B and x1B. Their corresponding chroma sample values are denoted as y0A, y1A, y0B and y1B. Then xA, xB, yA and yB are derived as:

Xa=(x0A+x1A+1)>>1;

Xb=(x0B+x1B+1)>>1;

Ya=(y0A+y1A+1)>>1;

Yb=(y0B+y1B+1)>>1

Finally, the linear model parameters α and β are obtained according to the following equations.

$$α = \frac{{Y}_{a} - {Y}_{b}}{{X}_{a} - {X}_{b}}$$

$$β = {Y}_{b} - α \cdot {X}_{b}$$

The division operation to calculate parameter a is implemented with a look-up table. To reduce the memory required for storing the table, the value “diff” (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

DivTable[]={0, 7, 6, 5, 5, 4, 4, 3, 3, 2, 2, 1, 1, 1, 1, 0}

This may have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H). In LM_L mode, only left template is used to calculate the linear model coefficients. To get more samples, the left template is extended to (H+W).

For a non-square block, the above template is extended to W+W, the left template is extended to H+H.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) = [ \begin{matrix}re {c}_{L} ( 2 i - 1 , 2 j - 1 ) + 2 \cdot r e {c}_{L} ( 2 i - 1 , 2 j - 1 ) + re {c}_{L} ( 2 i + 1 , 2 j - 1 ) + \\ re {c}_{L} ( 2 i - 1 , 2 j ) + 2 \cdot {rec}_{L} ( 2 i , 2 j ) + re {c}_{L} ( 2 i + 1 , 2 j ) + 4\end{matrix} ] ≫ 3$$

$${rec}_{L}^{′} ( i , j ) = [ \begin{matrix}r e {c}_{L} ( 2 i , 2 j - 1 ) + re {c}_{L} ( 2 i - 1 , 2 j ) + 4 \cdot {rec}_{L} ( 2 i , 2 j ) + \\ re {c}_{L} ( 2 i + 1 , 2 j ) + re {c}_{L} ( 2 i , 2 j + 1 ) + 4\end{matrix} ] ≫ 3$$

It is appreciated that only one luma line (general line buffer in intra prediction) is used to make the down-sampled luma samples when the upper reference line is at the CTU boundary.

This parameter computation is performed as part of the decoding process and is not just as an encoder search operation. As a result, no syntax is used to convey the a and R values to the decoder.

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in Table 1, below. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1
Derivation of chroma prediction mode from luma mode when cclm_is
enabled:

| | Corresponding luma intra prediction mode | | | | |
|---|---|---|---|---|---|
| Chroma prediction mode | 0 | 50 | 18 | 1 | X(0 <= X <= 66 ) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2, below.

TABLE 2
Unified binarization table for chroma prediction mode:

| | Bin |
|---|---|
| Value of intra_chroma_pred_mode | string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all other luma and chroma coding tree split conditions, CCLM is not allowed for chroma CU.

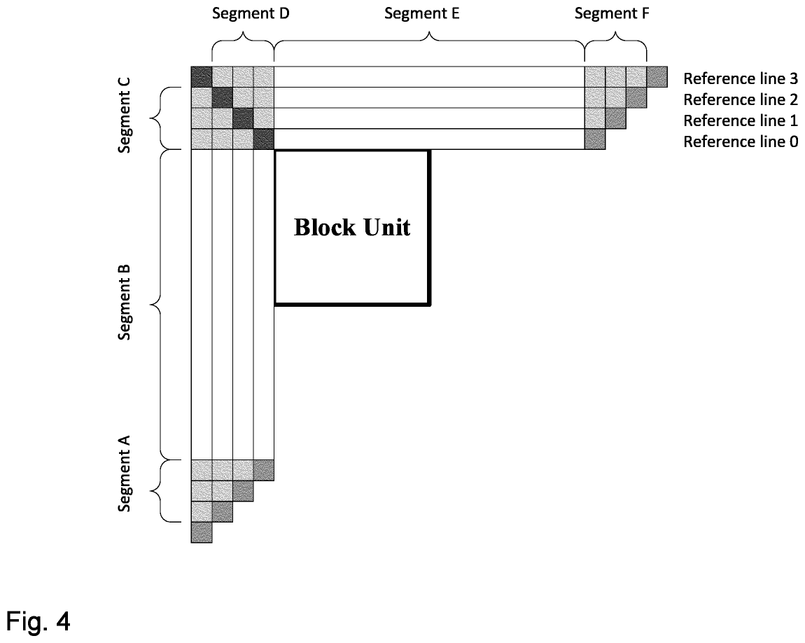

Multiple reference line (MRL) intra prediction uses more reference lines for intra prediction. In FIG. 4, an example of four reference lines (Reference lines 0, 1, 2, 3) is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) may be signalled in or along a bitstream, and used to generate intra predictor. For reference line idx, which is greater than 0, only additional reference line modes may be included in MPM list and only mpm index may be signaled without remaining mode. The reference line index may be signalled before intra prediction modes, and Planar mode may be excluded from intra prediction modes in case a nonzero reference line index is signalled.

MRL may be disabled for the first line of blocks inside a CTU to prevent using extended reference samples outside the current CTU line. Also, PDPC may be disabled when additional line is used. For MRL mode, the derivation of DC value in DC intra prediction mode for non-zero reference line indices are aligned with that of reference line index 0. MRL requires the storage of 3 neighboring luma reference lines with a CTU to generate predictions. The Cross-Component Linear Model (CCLM) tool also requires three neighboring luma reference lines for its down-sampling filters. The definition of MLR to use the same three lines is aligned as CCLM to reduce the storage requirements for decoders.

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB (transform block) and two corresponding M/2×64 chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. All sub-partitions fulfil the condition of having at least 16 samples.

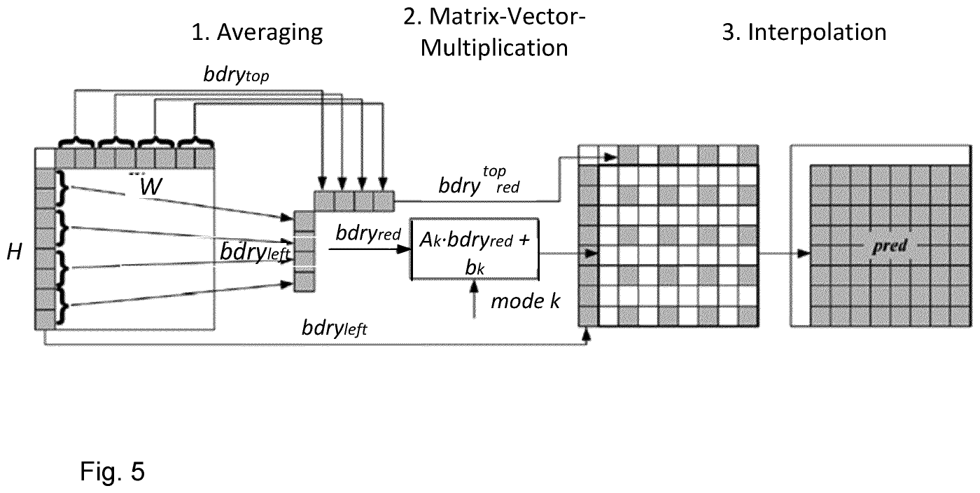

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. FIG. 5 shows an example of the matrix weighted intra prediction process, where the generation of the prediction signal is based on the following three steps, which are averaging, matrix vector multiplication and linear interpolation

One of the features of inter prediction in VVC is merging with MVD. A merge list may include the following candidate
1) Spatial motion vector prediction (MVP) from spatial neighbour CUs
2) Temporal MVP from collocated CUs
3) History-based MVP from a FIFO table
4) Pairwise average MVP (using the candidates already in the list)
5) Zero MVs.

Merged mode width motion vector difference (MMVD) is to signal MVDs and a resolution index after signaling merge candidate.

In Symmetric MVD, motion information of list-1 are derived from motion information of list-0 in bi-prediction case.

In Affine prediction, several motion vectors are indicated/signaled for different corners of a block, which are used to derive the motion vectors of sub-block. In affine merge, affine motion information of a block is generated based on the normal or affine motion information of the neighboring blocks.

In Sub-block-based temporal motion vector prediction, motion vectors of sub-blocks of the current block are predicted from a proper subblocks in the reference frame which are indicated by the motion vector of a spatial neighboring block (if available).

In Adaptive motion vector resolution (AMVR), precision of MVD is signaled for each CU.

In Bi-prediction with CU-level weight, an index is indicated the weight values for weighted average of two prediction block.

Bi-directional optical flow (BDOF) refines the motion vectors in bi-prediction case. BDOF is able to generate two prediction blocks using the signaled motion vectors. Then a motion refinement is calculated to minimize the error between two prediction blocks using their gradient values. The final prediction blocks are refined using the motion refinement and gradient values.

Transform is a solution to remove spatial redundancy in prediction residual blocks for block-based hybrid video coding. In addition, the existing directional intra prediction causes directional pattern in prediction residual and it leads to predictable pattern for transform coefficients. The predictable patterns in transform coefficients are mostly observed in low frequency components. Therefore, a low-frequency non-separable transform (LFNST) can be used to further compress the redundancy between low-frequency primary transform coefficients, which are transform coefficients from the conventional directional intra prediction.

Multiple Transform Selection (MTS) relies on three trigonometrical transforms, and at the encoder side, selects the couple of horizontal and vertical transforms that maximizes the Rate-Distortion cost.

In the decoder-side intra mode derivation (DIMD) method, the intra prediction direction or mode is derived from the previously coded/decoded pixels in both encoder and decoder side, hence the signalling of the mode is not required unlike the conventional intra prediction tools. The pixel/sample prediction with DIMD mode may be done as below:

In the Intra Prediction Mode (IPM) of decoder-side intra mode derivation blocks, a texture gradient analysis is performed at both encoder and decoder sides. This process starts with an empty Histogram of Gradient (HoG) with a certain number of entries corresponding to different angular intra prediction modes. In accordance with an approach, 65 entries are defined. Amplitudes of these entries are determined during the texture gradient analysis. The HoG computation may be carried out by applying, for example, horizontal and vertical Sobel filters on pixels in a template of width 3 around the block. If pixels above the template fall into a different CTU, then they will not be used in the texture analysis.

In the filtering two kernel matrices of size 3×3 is used with a filtering window so that pixel values within the filtering window A are convolved with the matrices. One of the matrices produces a gradient value Gx in horizontal direction at the center pixel of the filtering window and the other matrix produces a gradient value Gy in vertical direction at the center pixel of the filtering window. In other words, the center pixel and the eight pixels around the center pixel are used in the calculation of the gradient for the center pixel. The sum of absolute values of the two gradient values indicates the magnitude of the gradient and the inverse tangent (arctan) of the ratio of Gy/Gx indicates the direction of the gradient. If there is an edge in the filtering window the direction also indicates the angular intra prediction mode. The filtering window is moved to a next pixel in the template and the procedure above is repeated. In accordance with an approach, the above described calculation is performed for each pixel in the center row of the template region.

The Cross-Component Linear Model (CCLM) uses a linear model for predicting the samples in the chroma channels (e.g. Cb and Cr). The model parameters are derived based on the reconstructed samples in the neighbourhood of the chroma block, the co-located neighboring samples in the luma block as well as the reconstructed samples inside the co-located luma block.

The purpose of the CCLM is to find correlation of samples between two or more channels. However, the linear model of CCLM method is not able to provide precise correlation between the luma and chroma channels always, and consequently, the performance is sub-optimal.

Thus, the aim of the present embodiments is in improving the prediction performance of the Cross-component Linear Model (CCLM) prediction by providing a joint intra prediction in chroma coding. The joint intra prediction uses a combination of CCLM and an intra prediction mode that has been derived from a reference channel. This means that for a current block in a chroma channel, the derived intra prediction mode may be inherited from a co-located block in the luma channel. Alternatively, the derived mode may be based on the prediction mode(s) of the reconstructed neighboring blocks in the chroma channels (e.g., Cb and Cr).

The final prediction for the chroma block is achieved by combining the CCLM and derived prediction modes with certain weights.

In the following, the present embodiments are discussed in more detailed manner. The joint prediction method, according to embodiments, combines prediction of CCLM and a derived intra prediction mode. The joint prediction method is configured to predict the samples of the block based on the CCLM prediction and a traditional spatial intra prediction. The traditional intra prediction mode may be derived from the collocated block or a region in the collocated block in the reference channel of CCLM mode (e.g. luma channel).

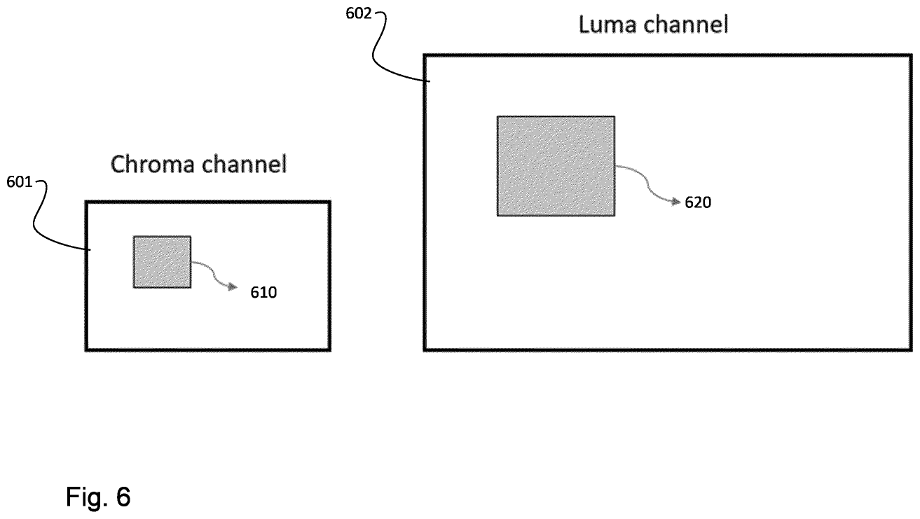

The derived traditional intra mode is used for finding further correlation between the samples of two channels. FIG. 6 shows an example of a coding block 610 in chroma channel 601 and the corresponding collocated block 620 in luma channel 602. If the block segmentations in different channels do not correspond to each other, the collocated block 620 may be determined by mapping a certain position in a chroma channel 601 to a position in a luma channel 602 and use the block in determined luma position as the collocated block 620. For example, top-left corner, bottom-right corner or the middle point of a chroma block can be used in this process as the reference chroma position.

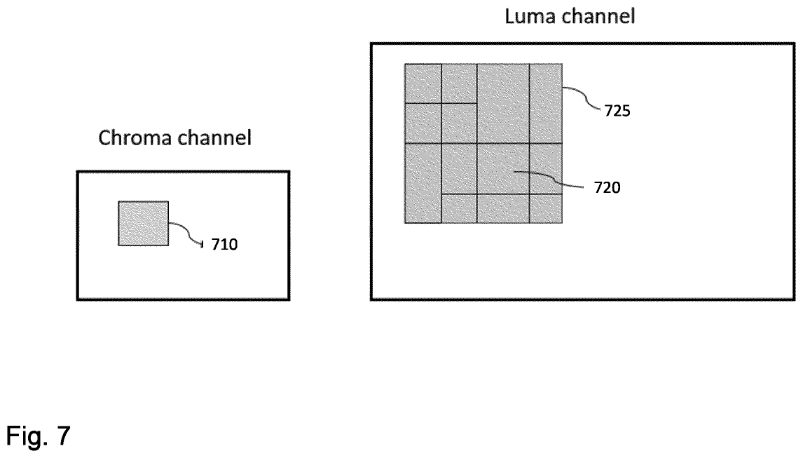

According to an alternative approach, the derived mode from the reference channel may not always be the collocated block. The derived mode may be decided based on the prediction mode of at least one of the blocks in an extended area in collocated location. This is illustrated in FIG. 7, showing the collocated block 720 an collocated neighborhood 725 for a coding block 710. In this case, the derived mode may be decided based on a rate-distortion (RD) performance of more than one prediction mode. As another example, the prediction mode with the largest sample area in the extended collocated neighborhood or the prediction mode associated with the largest luma block in the extended collocated neighborhood may be selected as the derived mode.

The overall process of a method according to an embodiment comprises:
a first prediction comprising predicting samples inside a block with a CCLM mode;
deriving an intra prediction mode from a coded block in the reference channel;
a second prediction comprising predicting the samples inside the block based on the derived intra prediction mode; and
determining the final prediction of the block based on the first and second prediction with pre-defined weights.

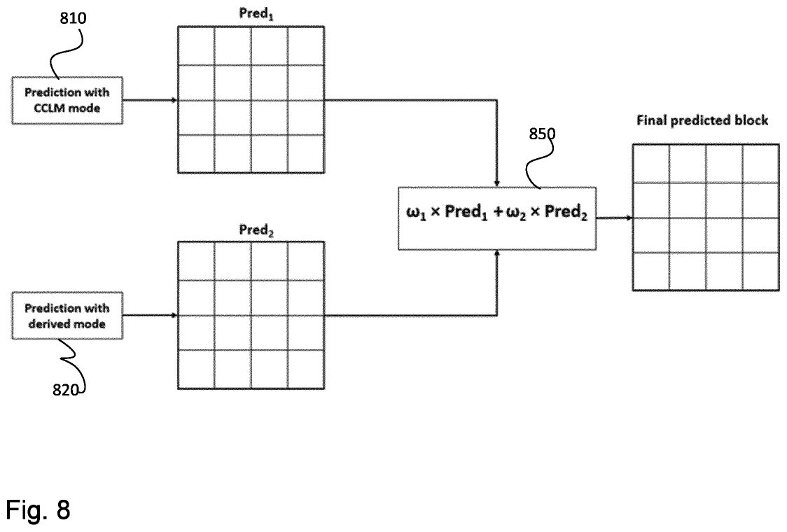

FIG. 8 illustrates an example of the process of joint prediction method, wherein the first and the second predictions are combined. The first prediction 810 is the prediction with the CCLM mode, and the second prediction 820 is the prediction with a derived mode. Both the first and the second predictions are weighted, when combined 850.

The weighting approaches for the combining 850 can be any of the following:
The first and second predictions may be combined with a constant equal weight for the entire samples of the block.
The first and second predictions may be combined with constant unequal weights for the entire samples of the block.
The first and second predictions may be combined with equal/unequal sample-wise weighting where the weights of each predicted sample may differ from others.
The weight values of the samples may be decided based on the prediction direction or the mode identifier of the derived mode.
The weight values of the samples may be decided based on the prediction direction, the location of the reference samples or the mode identifier of the CCLM mode.
The weight values of the samples may be decided based on the prediction directions, the locations of the reference samples or the mode identifiers of the CCLM and derived modes.
The weight values of the samples may be decided based on the size of the block. For example, the samples in the larger side of the block may use higher weights for the derived mode and lower weights for the CCLM mode or vice versa.
The weight values of a prediction block may be set to zero for some block positions. For example, the weight for the block generated with derived prediction mode may be zero when the distance from the top or left block edge is above a threshold.

The joint prediction process according to the embodiments may be applied in different scenarios as described in below:

The joint prediction may be applied to one of the chroma channels (e.g. Cb or Cr) and the other channel may be predicted based on the CCLM mode only or the derived mode only. The selection of the channel for applying the joint prediction may be fixed or based on a rate-distortion process in the codec.

Alternatively, each of the chroma channels may be predicted with using one of the modes. For example, one of the channels may be predicted based on the CCLM mode and the other channel may be predicted based on the derived intra mode. The selection of the prediction mode in each channel may be decided based on a rate-distortion process or may be fixed.

The derived mode for the second prediction may be decided based on the prediction modes of the neighboring blocks in the corresponding chroma channel.

The derived mode may be set to a predefined mode, such as a planar prediction mode or a DC prediction mode. The derived mode can also be indicated using a higher level signaling, e.g. including syntax elements determining the derived mode in slice or picture headers or in parameter sets of a bitstream. Alternatively, the derived mode can be indicated in transform unit, prediction unit or coding unit level, either separately of jointly for the different chroma channels.

According to an embodiment, the derived mode is different for the chroma channels. For example, the derived mode for one of the channels (e.g. Cb or Cr) may be decided based on the collocated block in the reference channel (e.g. luma channel) and the derived mode for the other chroma channel may be decided based on the prediction mode(s) of the neighboring blocks of that channel.

Any of the syntax element(s) needed for the present embodiments can be signalled in or along a bitstream. The signalling may be done in certain conditions such as CCLM direction, direction of the derived mode, position and size of the block, etc. Alternatively, the syntax element may be decided in the decoder side for example by checking the availability of CCLM mode, derived mode, block size, etc.

In another embodiment, the derived mode may be determined based on a texture analysis method from the reconstructed neighboring samples of the coding channel. For that, certain number of the neighboring reconstructed samples (or a template of samples) may be considered.

According to another embodiment, the texture analysis method for deriving the intra prediction mode may be one or more of the following: the decoder-side intra derivation (DIMD) method, template matching-based (TM-based) method, intra block copy (IBC) method, etc.

The mode derivation from the neighboring samples may consider the direction of the CCLM mode. For example, if the CCLM mode uses only the above neighboring samples then the mode may be derived according to only above neighboring samples or vice versa.

In case where the derived mode is achieved through the neighboring reconstructed samples, one mode may be derived for each channel based on the corresponding neighboring samples to be combined with the CCLM mode. Alternatively, the derived mode may be common for both chroma channels where it may be derived according to the neighboring reconstructed samples of both or either of the channels.

Similar to the joint prediction in previous cases, the derived mode that is achieved from texture analysis of neighboring samples may be applied to one channel and the other channel may be predicted with only CCLM mode. In an alternative way, the joint prediction may be applied to one channel only and the other channel may be predicted based on only CCLM or derived mode.

The weight values for combining the two prediction may be decided based on the texture analysis of neighboring reconstructed samples. For example, the intra prediction mode that is derived with DIMD mode includes certain weights in the derivation process of each mode. These weights or a certain mapping of these weights may be considered for weight decision of the derived and CCLM modes.

According to another embodiment, the transform selection (Multiple Transform Set (MTS), Low Frequency Non-Separable Transform (LFNST), etc.) or index of the transform in LFNST may be decided based on either or both of the derived and CCLM modes.

It needs to be understood that the present embodiments are not limited to only combining two predictions. The final prediction may be achieved by combing more than two predictions. For example, the final prediction may be calculated with one or more CCLM modes and one or more derived modes.

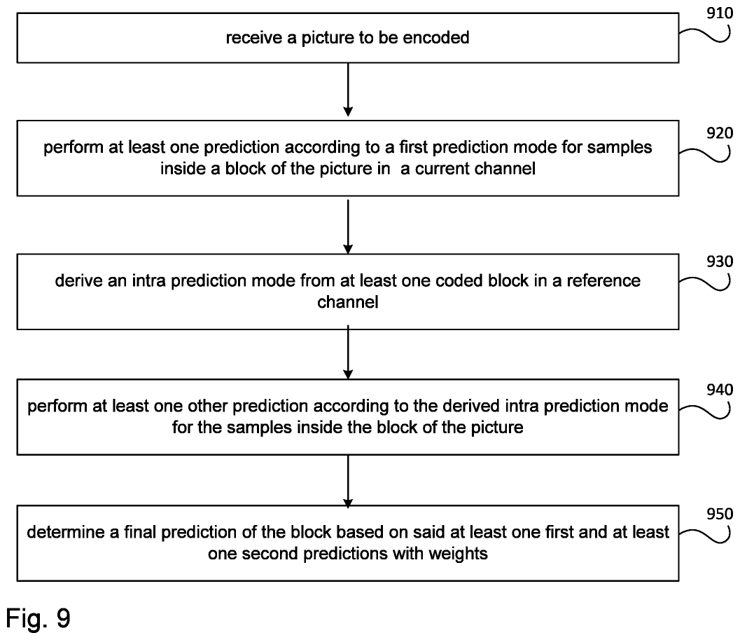

The method according to an embodiment is shown by a flowchart in FIG. 9. The method generally comprises receiving 910 a picture to be encoded; performing 920 at least one prediction according to a first prediction mode for samples inside a block of the picture in a current channel; deriving 930 an intra prediction mode from at least one coded block in a reference channel; performing 940 at least one other prediction according to the derived intra prediction mode for the samples inside the block of the picture; and determining 950 a final prediction of the block based on said at least one first and at least one second predictions with weights. Each of the steps can be implemented by a respective module of a computer system.

An apparatus according to an embodiment comprises means for receiving a picture to be encoded; means for performing at least one prediction according to a first prediction mode for samples inside a block of the picture in a current channel; means for deriving an intra prediction mode from at least one coded block in a reference channel; means for performing at least one other prediction according to the derived intra prediction mode for the samples inside the block of the picture; and means for determining a final prediction of the block based on said at least one first and at least one second predictions with weights. The means comprises at least one processor, and a memory including a computer program code, wherein the processor may further comprise processor circuitry. The memory and the computer program code are configured to, with the at least one processor, cause the apparatus to perform the method of FIG. 9 according to various embodiments.

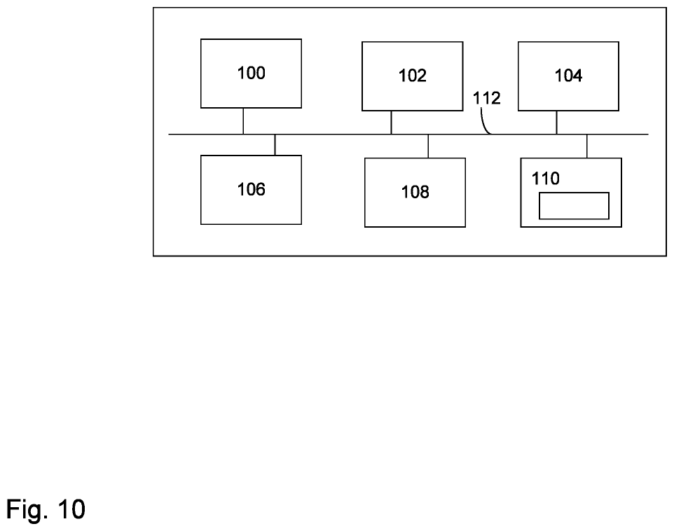

An example of an apparatus is shown in FIG. 10. The generalized structure of the apparatus will be explained in accordance with the functional blocks of the system. Several functionalities can be carried out with a single physical device, e.g. all calculation procedures can be performed in a single processor if desired.

A data processing system of an apparatus according to an example of FIG. 10 comprises a main processing unit 100, a memory 102, a storage device 104, an input device 106, an output device 108, and a graphics subsystem 110, where are connected to each other via a data bus 112. The main processing unit 100 is a processing unit arranged to process data within the data processing system. The main processing unit 100 may comprise or may be implemented as one or more processors or processor circuitry. The memory 102, the storage device 104, the input device 106, and the output device 108 may include other components as recognized by those skilled in the art. The memory 102 and storage device 104 store data in the data processing system 100. Computer program code resides in the memory 102 for implementing, for example, neural network training or other machine learning process. The input device 106 inputs data into the system while the output device 108 receives data from the data processing system and forwards the data, for example, to a display. While data bus 112 is shown as a single line, it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet table computer.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment. The computer program code comprises one or more operational characteristics. Said operational characteristics are being defined through configuration by said computer based on the type of said processor, wherein a system is connectable to said processor by a bus, wherein a programmable operational characteristic of the system are for implementing a method according to various embodiments.

A computer program product according to an embodiment can be embodied on a non-transitory computer readable medium. According to another embodiment, the computer program product can be downloaded over a network in a data packet.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1. An apparatus, comprising at least one processor, memory including computer program code, the memory and the computer program code configured to, with the at least one processor, cause the apparatus to perform at least the following:
receive a picture to be encoded;
perform at least one prediction according to a first prediction mode for samples inside a block of the picture in a current channel;
derive an intra prediction mode from at least one coded block in a reference channel;
performing at least one other second prediction according to the derived intra prediction mode, as a second prediction mode, for the samples inside the block of the picture; and
determine a final prediction of the block based on said at least one first and at least one second predictions with weights.

2. The apparatus according to claim 1, wherein the first prediction mode is a cross component linear mode.

3. The apparatus according to claim 1, wherein the derived intra prediction mode is derived from at least one collocated block in a channel different from the current channel.

4. The apparatus according to claim 1, wherein the derived intra prediction mode is derived from at least one neighboring block in the current channel.

5. The apparatus according to claim 1, wherein the derived intra prediction mode is determined based on a texture analysis method from reconstructed neighboring samples of the current channel.

6. The apparatus according to claim 5, wherein the texture analysis method comprises one of the following: a decoder-side intra derivation method; template matching-based method; intra block copy method.

7. The apparatus according to claim 5, wherein the determination from the neighboring samples considers a direction of the first prediction mode.

8. The apparatus according to claim 1, wherein the final prediction comprises combining the first and the second prediction modes with a constant equal weight for the samples inside the block of the picture.

9. The apparatus according to claim 1, wherein the final prediction comprises combining the first and the second prediction modes with constant unequal weights for the samples inside the block of the picture.

10. The apparatus according to claim 1, wherein the final prediction comprises combining the first and the second prediction modes with equal or unequal sample-wise weighting where the weights of each predicted sample differ from each other.

11. The apparatus according to claim 1, further comprising deciding the weight of the samples inside the block of the picture based on a prediction direction or a mode identifier of a derived intra prediction mode.

12. The apparatus according to claim 1, further comprising determining the weight of the samples inside the block of the picture based on a prediction direction, a location of reference samples or a mode identifier of the cross-component linear mode.

13. The apparatus according to claim 1, further comprising determining weight values of the samples based inside the block of the picture on the prediction directions, the locations of the reference samples or the mode identifiers of the cross-component linear mode and the derived prediction modes.

14. The apparatus according to claim 1, further comprising determining the weights of the samples inside the block based on a size of the block.

15. A method comprising:
receiving a picture to be encoded;
performing at least one prediction according to a first prediction mode for samples inside a block of the picture in a current channel;
deriving an intra prediction mode from at least one coded block in a reference channel;
performing at least one second prediction according to the derived intra prediction mode, as a second prediction mode, for the samples inside the block of the picture; and
determining a final prediction of the block based on said at least one first and at least one second predictions with weights.

16-28. (canceled)
